(19) United States
(12) Patent Application Publication
(10) Pub. No.: US 2020/0133825 A1
(43) Pub. Date: Apr. 30, 2020

(54) SYSTEMS AND METHODS FOR DEBUGGING APPLICATIONS CREATED WITH A GRAPHICAL PROGRAMMING LANGUAGE

(71) Applicant: salesforce.com, inc., San Francisco, CA (US)

(72) Inventors: William Charles Eidson, Palo Alto, CA (US); Jason Teller, San Bruno, CA (US)

(21) Appl. No.: 16/174,045

(22) Filed: Oct. 29, 2018

(51) Int. Cl. G06F 11/36

(52) U.S. Cl. CPC G06F 11/3664; G06F 3/0482; G06F 11/3636; G06F 11/3612

(57) ABSTRACT

A graphical programming debugging system and method are provided. The system, for example, may include, but is not limited to a graphical programming debugger comprising a processor and a memory, the processor configured to receive a selection of one of a plurality of interconnected nodes of an application, each of the plurality of interconnected nodes associated with a screen displayed to a user executing the application, execute the selected node, capture a log of the execution of the selected node, the log including a history of any variables used while the selected node was executed, a history of any processes which occurred during the execution of the selected node, and any errors encountered while executing the selected node, and simultaneously display the screen associated with the node as executed with the captured log.

### TECHNICAL FIELD

The following relates to application generation and debugging, and more particularly relates to systems and processes for debugging applications generated from a graphical programming language.

### BACKGROUND

Debugging an application can be a difficult and laborious process. Programs are often millions of lines of code long. Furthermore, execution logs tracking the execution of the program are often millions of lines long as well. Accordingly, debugging a program can often be difficult, like looking for a needle in a haystack.

### DESCRIPTION OF THE DRAWING FIGURES

Exemplary embodiments will hereinafter be described in conjunction with the following drawing figures, wherein like numerals denote like elements, and

FIG. 1 is a block diagram of an exemplary graphical programming system, in accordance with the embodiment;

FIG. 2 is an exemplary display of the application generator of the graphical programming generation system, in accordance with an embodiment;

FIG. 3 illustrates an exemplary virtual application generated using the application generator, in accordance with an embodiment;

FIG. 4 illustrates an exemplary screen, in accordance with an embodiment;

FIG. 5 illustrates an exemplary display of the graphical programming debugger, in accordance with an embodiment;

FIG. 6 illustrates an exemplary variable input interface of the graphical programming debugger, in accordance with an embodiment; and

FIG. 7 is a flow chart illustrating an exemplary method of operating the graphical programming debugger, in accordance with an embodiment.

### DETAILED DESCRIPTION

According to various exemplary embodiments, systems and methods are provided to debug applications creature using a graphical programming interface.

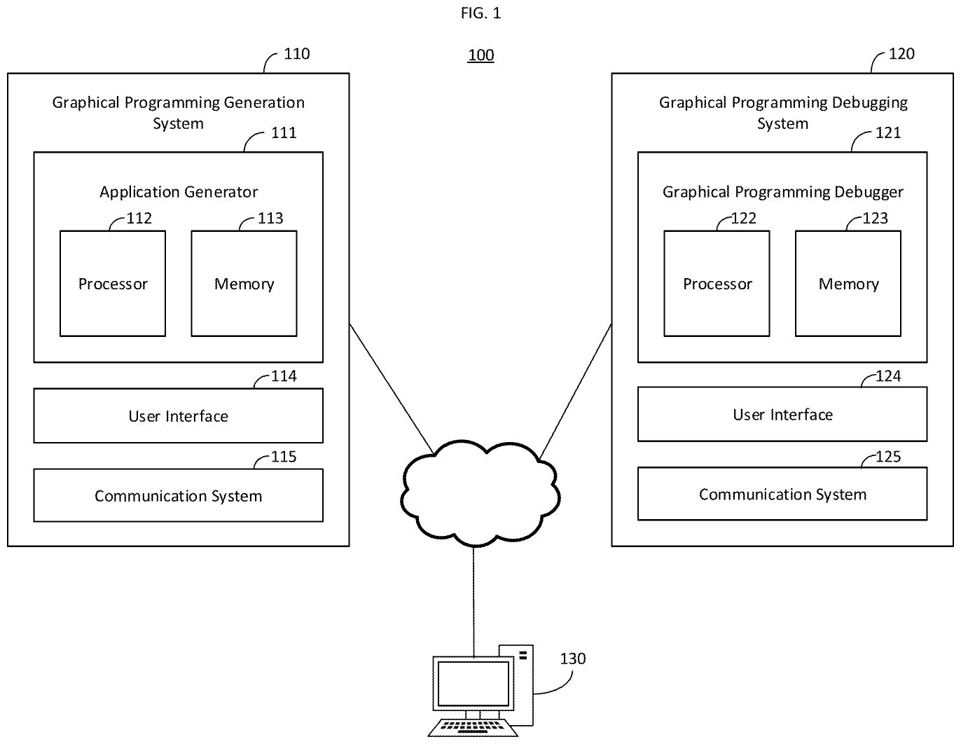

FIG. 1 is a block diagram of an exemplary graphical programming system 100, in accordance with the embodiment. The graphical programming system 100 includes a graphical programming generation system 110. The graphical programming generation system 110 may be used to generate an application without having to write any code. The application may be an executable application or a virtual application. In this context, the executable application may be installed or otherwise run on a computing device 130, such as a computer, a cellular phone, or the like. In contrast, the virtual application may be executable through a web browser or the like, and, thus may be executed without having to be installed on a computing device 130.

The graphical programming generation system 110 includes an application generator 111. The application generator 111 provides a graphical user interface (GUI) for generating the application. As discussed in further detail below, the application generator 111 provides an environment for generating an application without having to write any code. The application generator 111 may be used for simple or complex applications depending upon which tools are available to a user.

The application generator 111 includes a processor 112 and a memory 113. The processor 112 may be a central processing unit (CPU), a graphics processing unit (GPU), an application specific integrated circuit (ASIC), a field programmable gate array (FPGA), a microcontroller, or any other logic unit or any combination thereof. The memory 113 may be any combination of volatile and non-volatile memory. In one embodiment, for example, a portion of the memory 113 may be a cloud-based memory remote from the graphical programming generation system 110 and accessible via a data connection. The memory 113 may include non-transitory instructions for executing the application generator 111 as discussed in further detail below.

In one embodiment, for example, the graphical programming generation system 110 may be a server. In this embodiment, the application generator 111 may itself be a virtual application accessible on the graphical programming generation system 110 via the computing device 130. In another embodiment, the graphical programming generation system 110 may be a computing device such as a desktop computer, a laptop, a cellular phone, a tablet, or the like.

In one embodiment, for example, the graphical programming generation system 110 may include a user interface 114. The user interface 114 may include one or more of a display, a touch screen interface, a mouse, a trackpad, a trackball, a keyboard, voice recognition, or the like, or any combination thereof. The graphical programming generation system 110 may further include a communication system 115. The communication system 115 may utilize any wired or wireless communication systems.

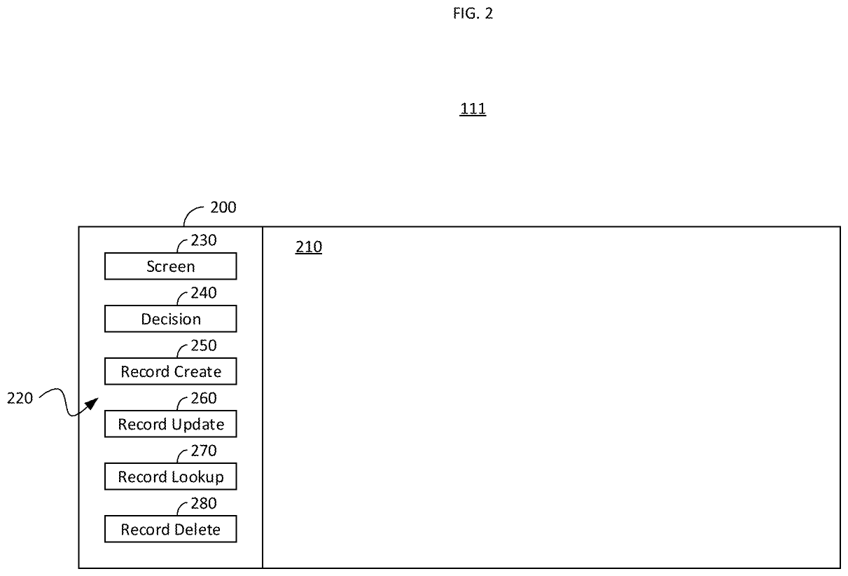

FIG. 2 is an exemplary display of the application generator 111 of the graphical programming generation system 110, in accordance with an embodiment. The application generator 111 includes a palette 200 and a canvas 210. The palette 200 includes numerous tools 220 representing different nodes which can be added to the canvas 210 by, for example, a drag and drop action by a user. In the embodiment illustrated in FIG. 2, the tools 220 include a screen 230, a decision 240, a record create 250, a record update 260, a record lookup 270 and a record delete 280. However, the number of tools and the functions thereof may vary widely. The tools may include standard tools which are available to all users of the application generator 111, such as those discussed above, and custom tools which may be generated for a specific customer of the application generator 111. For example, a customized process used by the customer may be added as a tool such as a custom quote generation for a business, custom secured login screens using protocol defined by the customer, contact information gathering, appointment scheduling, filing an insurance claim, device or product troubleshooting, or the like. Each tool 220, when added to the canvas 210 becomes a node of a type associated with the tool. For example, when a user adds a screen tool 230 to the canvas 210, a screen node is added to the virtual application. Accordingly, a user can build a virtual application by adding nodes to the canvas 210 and customizing those nodes thereby building the virtual application without having to do any coding.

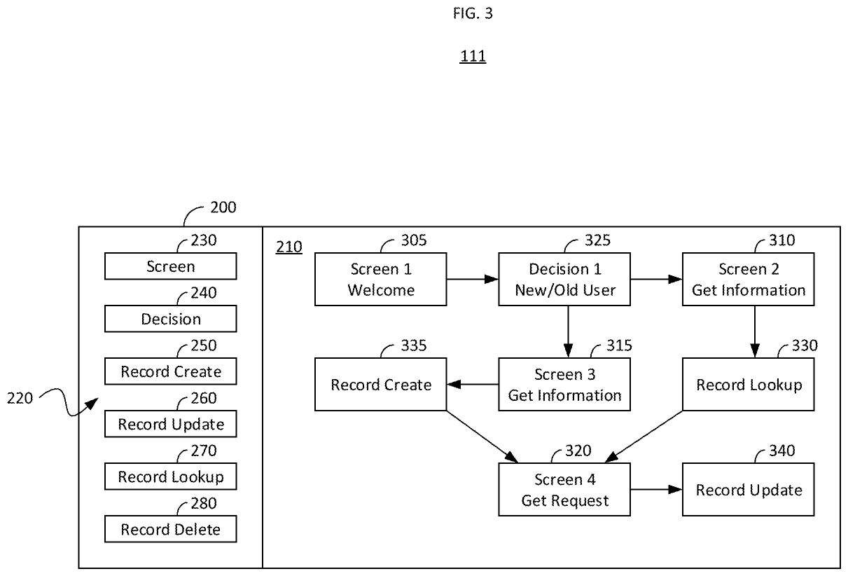

FIG. 3 illustrates an exemplary virtual application 300 generated using the application generator 111. In this example, the virtual application 300 gets a request from a user of the virtual application 300 and associates the request with the user. The virtual application 300 illustrated in FIG. 3 includes eight nodes, including four screens nodes 305, 310, 315 and 320, a decision node 325, record lookup node 330, a record create node 335, and a record update node 340.

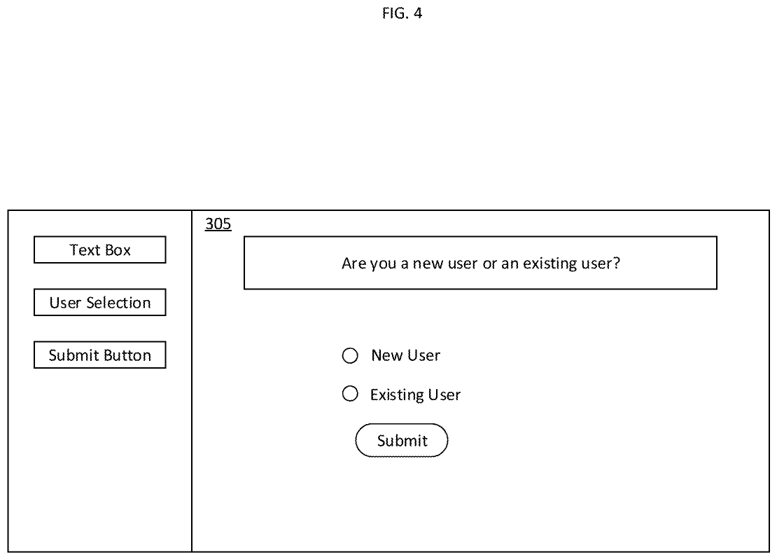

As discussed above, the screen tool 230 allows a user to add one or more screen nodes to their virtual application. Each screen node is a customizable display which allows the virtual application to display information to the user or collect information from the user. In one embodiment, for example, a wizard may be displayed to the user after a node is added to the canvas 210, which walks to user through the process of creating the specific node. In another embodiment, tools, like the tools 220 illustrated in FIG. 2, may be used to create the node. FIG. 4 illustrates an exemplary screen in accordance with an embodiment. In particular, FIG. 4 illustrates screen node 305 illustrated in FIG. 3. As seen in FIG. 4, the screen requests the user to submit whether they are a new user or an existing user. The screen node 305 is built using the tools 220 in the palette 200 which a specific to the screen tool 230. The tools 220 illustrated in FIG. 4 include a text box, a user section tool and a submit button. The text box allows the user creating the virtual application to add text to the screen node 305. The user selection tool allows the user creating the application to present to a user operating the virtual application choices, such as drop-down menus, radio buttons, check boxes or the like. The submit button allows the user to submit their selection to the virtual program. The tools illustrated in FIG. 4 are merely exemplary and could include any number of tools allowing the screen to include any feasible function. Accordingly, the user can customize each node by dragging and dropping tools associated with the node onto the canvas for the node, by using a wizard, or any combination thereof. In one embodiment, for example, the tools associated with the node may have wizards or the like to help the user build the node.

Returning to FIG. 3, the other tools 220 allow the virtual application to process information collected from a screen node. For example, the decision tool 240 may be used to switch between multiple paths of the virtual application based upon user input. For example, as seen in FIG. 3, the decision node determines if the user selected the new user option or the existing user option and sends the application along a path associated with the selection option. The record create tool 250, the record update tool 260, a record lookup tool 270 and a record delete tool 280 may create, modify, lookup or delate a record in a database associated with the virtual application. The record may be, for example, a user profile, a business contact, an opportunity, or the like. The application generator 111, once the user has completed the application, then converts the created nodes into code for the virtual application.

The application, once created, could be millions of lines of code long, depending upon the complexity of the respective application. Likewise, execution logs tracking the execution of the application maybe millions of lines long. When an error occurs during the execution of the application, debugging the application may been difficult, particularly for the user who created the application who may know nothing about coding or for an administrator or other support member tasked with debugging the application who is unfamiliar with the application.

Accordingly, as illustrated in FIG. 1, the graphical programming system 100 further includes a graphical programming debugging system 120. The graphical programming debugging system 120 includes a graphical programming debugger 121. The graphical programming debugger 121 generates an environment for debugging the generated application. The graphical programming debugger 121 offers debugging features specific a graphical programming environment to assist in debugging an application created using the application generator 111, as discussed in further detail below.

The graphical programming debugger 121 includes a processor 122 and a memory 123. The processor 122 may be a central processing unit (CPU), a graphics processing unit (GPU), an application specific integrated circuit (ASIC), a field programmable gate array (FPGA), a microcontroller, or any other logic unit or any combination thereof. The memory 123 may be any combination of volatile and non-volatile memory. In one embodiment, for example, a portion of the memory 123 may be a cloud-based memory remote from the graphical programming debugging system 120 and accessible via a data connection. The memory 123 may include non-transitory instructions for executing the graphical programming debugger 121 as discussed in further detail below.

While the graphical programming debugging system 120 and the graphical programming generation system 110 are illustrated as separate elements, the respective systems may be a single computing device, such as a server, a personal computer, or the like. Additionally, even if the graphical programming debugging system 120 and the graphical programming generation system 110 are separate systems, they may share resources such as a cloud-based memory.

In one embodiment, for example, the graphical programming debugging system 120 may be a server. In this embodiment, the graphical programming debugger 121 may itself be a virtual application accessible on the graphical programming debugging system 120 via the computing device 130. In another embodiment, the graphical programming debugging system 120 may be a computing device such as a desktop computer, a laptop, a cellular phone, a tablet, or the like.

In one embodiment, for example, the graphical programming debugging system 120 may include a user interface 124. The user interface 124 may include one or more of a display, a touch screen interface, a mouse, a trackpad, a trackball, a keyboard, voice recognition, or the like, or any combination thereof. The graphical programming debugging system 120 may further include a communication system 125. The communication system 125 may utilize any wired or wireless communication systems.

The graphical programming debugger 121 combines the execution of the application with a log associated with the application. In particular, the graphical programming debugger 121 combines the execution of each node of the application with a log of the execution of the node. Unlike typical debugging procedures where a user would have to manually insert numerous stops in an application to evaluate, for example, a call stack at various points in the application to try and find an error, the graphical programming debugger 121 steps through the generated application one node at a time. Furthermore, unlike typical debugging systems which generates a single log, which could be millions of lines of code long, the graphical programming debugger 121 displays the log associated with the node with the screen associated with the node.

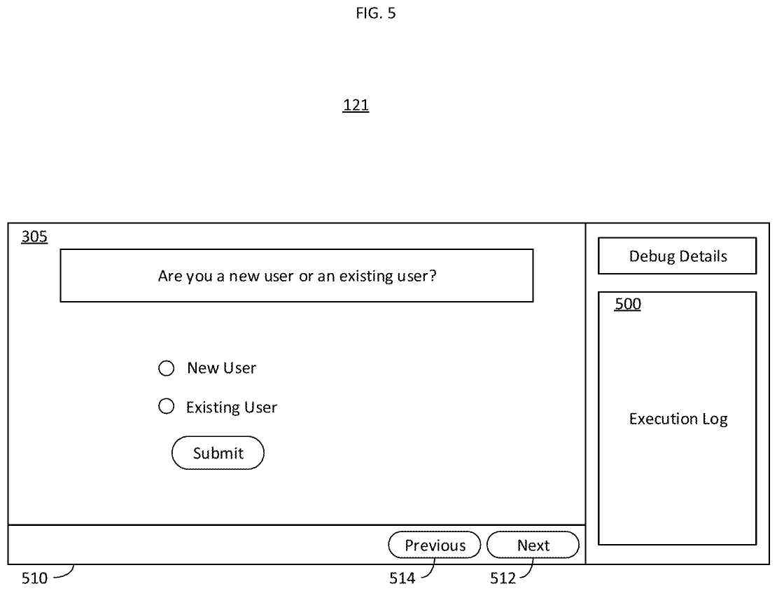

FIG. 5 illustrates an exemplary display of the graphical programming debugger 121, in accordance with an embodiment. In particular, FIG. 5 illustrates the graphical programming debugger 121 acting upon the screen node 305 illustrated in FIG. 3. As seen in FIG. 5, the graphical programming debugger 121 includes a display of the node (i.e., screen node 305). This gives context to the user preforming the debugger of the current state of the application that may be otherwise difficult to determine by reading code or reading a single execution log of the entire execution of the application.

As discussed above, the graphical programming debugger 121 includes an execution log 500 displayed simultaneously with the screen associated with the executed node. The execution log 500 includes details of the execution of the node. The execution log may include, for example, decision logic, variable assignment results, code invocation results, record create results, record update results, record delete results, record query results, user specifies input, looping results, error results, or the like, and any combination thereof. Because the execution log 500 is displayed with the respective node, context is given to the data within the execution log 500, making it easier for a user to identify where within the application the error is occurring.

The graphical programming debugger 121 further includes a progression interface 510. In this embodiment, the progression interface 510 includes a next butting 512 and a previous butting 514. However, the progression interface 510 could take a variety of forms. Unlike typical debugging procedures, which only allow a user to progress through an application in a single direction, namely from start to finish, the progression interface 510 allows the user to progress through the application in either direction. This allows a user to see how certain portions (e.g., variables) of the application change before and after the execution of the node.

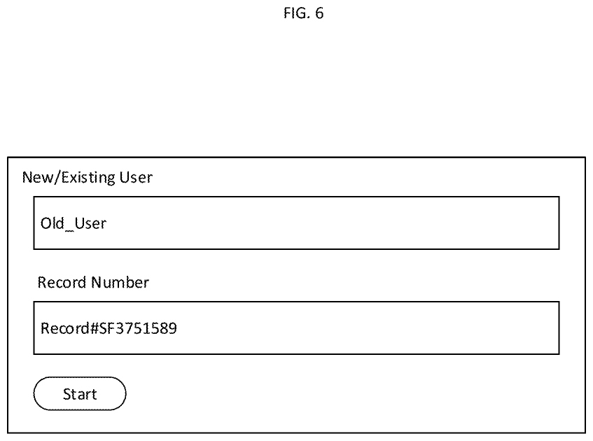

In one embodiment, for example, before the graphical programming debugger 121 begins executing the application, the graphical programming debugger 121 may give the user the opportunity to enter variables into the application. FIG. 6 illustrates an exemplary variable input interface 600 of the graphical programming debugger 121, in accordance with an embodiment. As seen in FIG. 6, the variable input interface 600 includes a list of all of the variables in the application. In this embodiment illustrated in FIG. 6, two variables are listed, a New/Existing User variable and a Record Number variable, which correspond to the exemplary application illustrated in FIG. 3. Accordingly, as the graphical programming debugger 121 progresses through the application, the input variables are automatically input and applied. This allows the user operating the debugging application to replicate the experience of someone who reported an error, for example, by allowing the user executing the graphical programming debugger 121 to follow the same path and use the same variables as someone who reported an error. If one of the values is left blank, a default value set by the application designer when programming the application would be used.

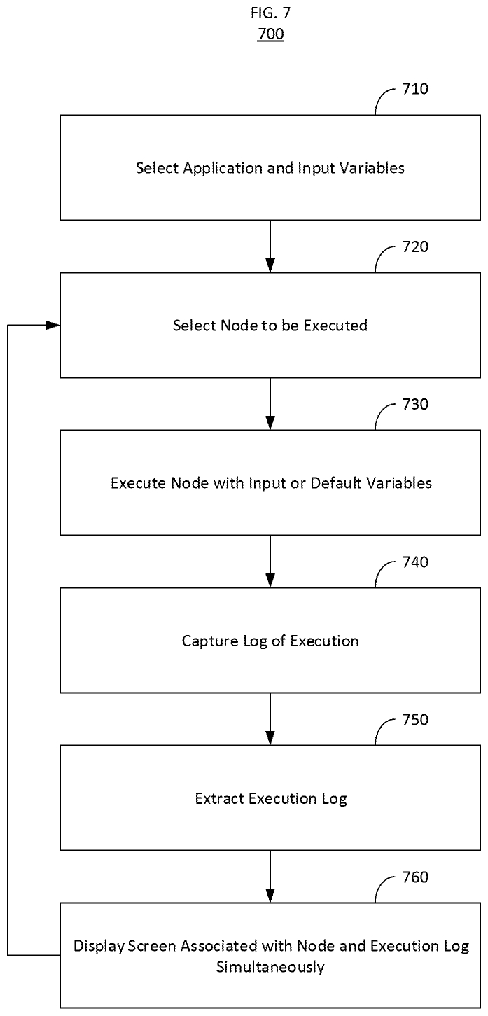

FIG. 7 is a flow chart illustrating an exemplary method of operating the graphical programming debugger 121, in accordance with an embodiment. The method begins when the user selects an application to debug and, optionally, inputs variables for the application during the execution of the graphical programming debugger 121. (Step 710). As illustrated in FIG. 6, an input interface 600 may be presented to the user to give the user the option of inputting variables. If the variables are left blank by the user, the graphical programming debugger 121 may use default values when executing the nodes.

The graphical programming debugger 121 then receives a selection of a node to be executed. (Step 720). For example, the user may select a node by clicking the start button of the variable input interface 600 or by using the progression interface 510. While the progression interface 510 illustrated in FIG. 5 utilizes next and previous buttons, other interfaces, such as a list of all nodes, may be used to select the node. The selected node may be downstream from a previously selected node or upstream from a previously selected node. In other words, and as discussed above, the user may progress through the application in either direction. Using FIG. 3 as an example, if the last node which was analyzed is screen node 315, the decision node 325 is upstream from screen node 315 and the record create node 335 is downstream from the screen node 315.

A processor, such as the processor 112, the processor 122 or a processor of a computing device 130, then executes the selected node using the variables input by the user or default variables. (Step 730). During execution of the node a processor may capture an execution log of the execution of the application and store the log in a memory. (Step 740). Any processor and memory in the graphical programming system 100 may capture and store the log, including the processor 112, the processor 122, a processor of the computing device 130, the memory 113, the memory 123 or a memory of the computing device 130, or any combination thereof. In one embodiment, for example, each node may be executed and captured one at a time, as discussed above. However, in another embodiment, the application may be executed from screen node to screen node. In this embodiment, intermediate nodes, such as decision nodes, or record-based nodes, may also be executed based upon the input variables, or default values, the execution of which can be captured and presented to the user all at one time.

The graphical programming debugger 121 then extracts, from the execution log, debugging information associated with the executed node. (Step 750). The extracted execution log, along with the screen related to the node are then displayed to the user. (Step 760). Because the execution log is displayed along with the screen associated with the node, the user can more easily locate and correct bugs in the application. The graphical programming debugger 121 then extracts then returns to Step 720 to await the next selection of a node to be executed. As discussed above, the user may go forwards and backwards through the application, allowing the user to see how each node changes variables, stacks and the like, giving the user a better appreciate of how each node is affecting the program and how each node may be contributing to an error in the application.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method for debugging an application created by a user using a graphical user interface (GUI) provided by an application generator in a graphical programming language, comprising:
selecting a node of the application, wherein the application comprises a plurality of interconnected nodes, each node of the plurality of interconnected nodes having been added to the application by adding a tool to a canvas associated with a respective screen to be displayed on the GUI to a user executing the application, at least one of the plurality of nodes being a create, read, update or deletion action associated with a database;
executing the selected node; and
while executing the selected node,
(i) capturing a log of the execution of the selected node, the captured log including a history of any variables used while the selected node was executed, a history of any processes which occurred during the execution of the selected node, and any errors encountered while executing the selected node; and
(ii) simultaneously displaying the screen displayed on the GUI associated with the node and the captured log of the execution.

2. The method according to claim 1, wherein the selected node is downstream from a previously selected node.

3. The method according to claim 1, wherein the selected node is upstream from a previously selected node.

4. The method according to claim 1, further comprising receiving input variables for the application before the execution of the selected node.

5. The method according to claim 1, wherein when the plurality of interconnected nodes includes at least two screen nodes and the selected node is one of the at least two screen nodes, and wherein executing the selected node further comprises executing each of multiple interconnected nodes between the at least two screen nodes.

6. The method according to claim 1, wherein the captured log further comprises decision logic, variable assignment results, code invocation results, record create results, record update results, record delete results, record query results, user specifies input, looping results and error results.

7. A graphical programming system, comprising:
a graphical programming generation system, the graphical programming generation system comprising an application generator configured to provide a graphical user interface (GUI) in a graphical programming environment for a user to generate an application comprising a plurality of interconnected nodes, each node added to the application by the user adding a tool to a canvas associated with a respective screen to be displayed on the GUI during execution of the application in the graphical programming environment; and
a graphical programming debugger comprising a processor and a memory, the processor configured to:
select a node of the plurality of interconnected nodes of the application;
execute the selected node; and
while executing the selected node:
capture a log of the execution of the selected node, the captured log including a history of any variables used while the selected node was executed, a history of any processes which occurred during the execution of the selected node, and any errors encountered while executing the selected node; and
simultaneously display the screen displayed on the GUI associated with the node and the captured log of the execution.

8. The graphical programming system of claim 7, wherein the selected node is downstream from a previously selected node.

9. The graphical programming system of claim 7, wherein the selected node is upstream from a previously selected node.

10. The graphical programming system of claim 7, further comprising receiving input variables for the application before the execution of the selected node.

11. The graphical programming system of claim 7, wherein tools in the graphical programming environment comprise:
a screen tool configured to display a screen upon execution of the application; and
a plurality of tools to process data collected from an associated screen.

12. The graphical programming system of claim 11, wherein when the selected node is based upon one of the plurality of tools configured process data collected from the associated screen, the screen displayed with the captured log is the associated screen.

13. The graphical programming system of claim 11, wherein the processor is further configured to execute each node associated with a selected screen and capture and display a log of the selected screen and each node associated with a selected screen.

14. The graphical programming system of claim 11, wherein the captured log further comprises decision logic, variable assignment results, code invocation results, record create results, record update results, record delete results, record query results, user specifies input, looping results and error results.

15. A graphical programming debugging system, comprising:
a communication system configured to receive an application generated using a graphical programming environment, the application comprising a plurality of interconnected nodes each node of the plurality of interconnected nodes having been added to the application by adding a tool to a canvas associated with a respective graphical user interface (GUI) screen to be displayed during execution of the application;
and
a graphical programming debugger comprising a processor and a memory, the processor configured to:
receive a selection of one of the plurality of interconnected nodes of the application;
execute the selected node;
capture a log of the execution of the selected node, the captured log including a history of any variables used while the selected node was executed, a history of any processes which occurred during the execution of the selected node, and any errors encountered while executing the selected node; and
simultaneously display the screen displayed on the GUI associated with the node and as executed with the captured log of the execution.

16. The graphical programming debugging system of claim 15, wherein the selected node is downstream from a previously selected node.

17. The graphical programming debugging system of claim 15, wherein the selected node is upstream from a previously selected node.

18. The graphical programming debugging system of claim 15, further comprising receiving input variables for the application before the execution of the selected node.

19. The graphical programming debugging system of claim 15, wherein the graphical programming environment comprises:
a screen tool configured to display a screen upon execution of the application; and
a plurality of tools configured to process data collected from an associated screen.

20. The graphical programming debugging system of claim 19, wherein when the selected node is one of the plurality of tools configured process data collected from the associated screen, the screen displayed with the captured log is the associated screen.
